(19) United States
(12) Patent Application Publication
(10) Pub. No.: US 2008/0206698 A1
(43) Pub. Date: Aug. 28, 2008

(54) Dynamic Expanding Application Technology

(76) Inventor: Xue Song Su, Beijing (CN)

Correspondence Address: HESLIN ROTHENBERG FARLEY & MESITI PC, 5 COLUMBIA CIRCLE, ALBANY, NY, 12203, US

(21) Appl. No.: 11/997,445

(22) PCT Filed: Jul. 28, 2006
(86) PCT No.: PCT/CN2006/001883

§ 371 Date: Jan. 31, 2008

(30) Foreign Application Priority Data
Aug. 1, 2005 (CN) 200510088643.7

(51) Int. Cl. F27D 1/16

(52) U.S. Cl. 432/3

(57) ABSTRACT

A technique for the application extension of dynamic technology includes modifying a prior art static technology into a corresponding dynamic technology, and relates to a method for dynamically improving the material quality, construction and parameter of a technological equipment. The material quality, construction, parameter, and pertinent working and manufacturing process of the weak link in prior art are modified by applying a selective combination of dynamic technology, hereby to improve the quality, function, performance, accuracy, purity, high temperature, high pressure, high energy stream density etc. Typical application of the said selective combination includes dynamic electrode, dynamic spraying gun, dynamic industrial furnace, dynamic material production, dynamic high energy battery, dynamic strong electric light source, dynamic laser and dynamic nuclear reactor.

### TECHNICAL FIELD

This invention pertains to a technique for the application extension of dynamic technology, relates to a method for modifying a prior art static technology into a corresponding dynamic technology or a method for modifying a prior art dynamic technology into a corresponding improved dynamic technology, and in particular relates to a method for dynamically improving the material quality, construction and parameter of a technological equipment.

### BACKGROUND ART

Generally all technologies involve two major parts including process and equipment, or software and hardware. During the initial stage of technology development, most are relatively static, namely, between each component of each process and the parameter thereof, between the overall equipment status and each component of an equipment, it is generally relatively static: that is, for prior art dynamic links (power, transmission, actuating mechanism), generally only fixed and simple mechanical motion state (most are relatively static or in relatively simple uniform motion) can easily constitute highly reproducible technical system relations. Static relations are tangible, direct and unitary, and the technology is easy to be realized, popularized and applied (easy to be industrialized). When developed to certain stage, static technology will encounter limitations, while dynamic technology can often break such limitations and explore much broader fields.

For example, as for forming technology, the relatively static technology utilizes molds (molding method), while dynamic technology utilizes the motion between cutting tools (tools) and workpieces for forming (generating method); the generating method explores much broader forming fields where molding method is difficult or impossible to be applied at all.

For another example, generally when electrode works, anode and cathode are relatively static, while for electric spark machining, the anode and cathode are dynamic, generally the cathode (tool) are moving relative to anode (workpiece), thus the problem that static electrodes are prone to be consumed or even burned out is solved, and a thin copper wire can also cut hard steel.

The prior art dynamic technologies have the following deficiencies:

1. The extensive and intensive theoretical investigation is far from enough. The theoretical basis of prior art are usually relatively static, which cause great blind zone for engineering technical personnel who are accustomed to prior art system in their innovation efforts and make them seldom conceive of or hardly can utilize a motion state different from prior art system to realize significant technological breakthrough.

2. The prior art dynamic devices are of single construction, single function and feature narrow application range. For example the aforementioned generating method tools are often restricted to mechanical cutting tools, and the electrothermal “cutting” in electric spark machining is not widely used in such tools; with dynamic electrode, electric spark machining has solved the problem that static electrodes are prone to be consumed or even burned out, while in the prior art, this precious merit is not extended to applications in metallurgy, architecture, petrochemistry, power generation (including battery), lighting, energy sources, oceans, traffics, spaces, bioengineering, nuclear reactions and other advanced manufacturing fields and material fields.

3. The operating temperature of prior art dynamic devices are mostly not high, and the cases higher than the melting point of the device material are often recognized as impossible; the cooling is often made externally and the cooling intensity is low.

4. The construction, form, fabrication cost, material quality and power supply of prior art dynamic devices are difficult to find widely extended applications; this is mainly due to that they are substantially produced and developed under the background of the above three deficiencies, most of them are small in power, high in fabrication cost, and are generally limited to specific processing applications within small range.

5. The prior art dynamic devices are limited to rigid bodies.

### DISCLOSURE OF INVENTION

The aim of this invention is to overcome the deficiencies in prior art dynamic technologies and make them gain extended applications in larger scope.

The prior art dynamic technologies have many potential precious merits, and these merits can generally bring about epoch-making effect on the further development of prior art static technologies. They have solved some bottle-neck technical problems that cannot be solved by static technologies at all, while unfortunately, these merits are neglected for long, and are only utilized in a few specific processing fields. In this invention, various approaches and measures are taken to further develop these merits and extend their applications to broad technical fields, hence, the large technical blind zone caused by the technical concept predominated by the long-standing traditional static technology concept can be overcome; the severe technical preoccupation formed by the technical system predominated by the long-standing traditional static technology system can be changed; large technical advancement can be gained, significant industrial application effect can be achieved; and outstanding commercial success can be made, great economic benefit can be obtained.

The large technical blind zone aimed to be overcome and the severe technical preoccupations aimed to be changed in this invention are currently widespread. Such severe technical preoccupation is traditional, even classical, and has penetrated into almost all the technical fields, leading to that systematic severe deficiencies occur in their foundation, core and major technical links, persons skilled in the art are only accustomed to ponder over problems according to static system, and there are a variety of severe technical preoccupations in the various schemes and facts that can be produced in the corresponding multidimensional dynamic system while are largely different from those in traditional static system:

Firstly, with respect to single fundamental technical parameter, the widespread incorrect understanding is that the mode determined by the traditional static rule is most preferred. For example:

1) When it is required to raise the operating temperature of a construction member, it is believed that the most preferred technical scheme is naturally to choose a material that can bear higher temperature for the manufacture of the member, while it is always not conceived of, not believed or even radically denied that the most preferred technical scheme might be the corresponding dynamic modification to the member: that is, to modify the prior art static construction member into a corresponding dynamic construction member, to modify the prior art dynamic construction member into an improved dynamic construction member, with no variations made to material, and even the choosing of material that can only bear lower temperature is allowed.

2) When it is required to raise the operating pressure of a device, it is believed that the most preferred technical scheme is naturally to choose a material and construction that can bear higher pressure, while it is always not conceived of, not believed or even radically denied that the most preferred technical scheme might be the corresponding dynamic pressure bearing device, at this time, the material and construction can be kept unchanged, and even the choosing of material and construction that can only bear lower pressure under static condition is allowed.

Secondly, with respect to larger technical links and technical system, the widespread incorrect understanding is that since the traditional static technology is classical and is the basis of prior art, they should be strictly taught by textbooks and reference books, and even if improved dynamic technical system is possible to appear, it is the matter of future. In this invention, we propose to gradually change traditional static technical system into the corresponding dynamic technical system, and we believe that this technical task which is believed as unnecessary, or impossible, or unpractical, not conceived of, not believed or even radically denied just represents the inevitable development trend of prior art.

Thirdly, with respect to larger technical concept, the major widespread incorrect understandings include:

1) With the development of modern technical economy, especially the development of intellectual economy, the primary competition means taken by leading multinational groups is to build appropriate patent pools (bounded patent cluster made up of more than thousand in amount), it is widely believed that the development trend of patent pools is to involve more and more patents in each pool (most are patents generated in the traditional static technical field), the evaluation of patent pools and intellectual property is mainly based on the comparison of absolute amount, while less or difficult to base on the comparison of relative quality, and which is an objective reality hardly to be changed. It is not conceived of, not believed or even radically denied that if to change into the corresponding dynamic technology patent pools, the amount may be reduced for 1-2 orders of magnitude, while higher quality, improved industrial application effect and greater commercial value are possible.

2) It is believed that the development trend of patent and intellectual property observes the rule of “information explosion” and is inevitably to suffer from “patent explosion”, “intellectual property explosion”, and the only resolution is to rely on information processing technology and build up corresponding storage link to extend the function of human brain; it is not conceived of, not believed or even radically denied that dynamic technology modification information modification and the similar technology modification information modification have the possibility to become one important means for solving the puzzles of “knowledge explosion”, “information explosion”, “patent explosion”, and “intellectual explosion”.

The aim of this invention can be realized through the following approaches:

This invention relates to a technique for the application extension of dynamic technology, which is mainly characterized in that, to change a motion state parameter of a prior art technical link, including to change the construction, material quality and parameter of a prior art technical link, it is generally to firstly change a certain or some prior art technical links from stationary into relatively moving, and then choose, based on the specific technical matter or technical problem intended to be solved, proper combinations from the following various approaches and measures for the realization of extended application of prior art dynamic technology, to render appropriate modification, including modifying a prior art static technical link into a corresponding dynamic technical link, or modifying a prior art dynamic technical link into a corresponding improved dynamic technical link; gradually modifying a prior art static technology into a corresponding dynamic technology, or gradually modifying a prior art dynamic technology into a corresponding improved dynamic technology, to break through the limited threshold value in the art, and realize transnormal or even significantly transnormal application field extension and application effects.

The said various approaches and measures for the realization of extended application of prior art dynamic technology include at least one of the following:

1) Extending application into a field that requires higher operating temperature, further including extending application into a field that requires to keep operating temperature unchanged while the service life in temperature link is improved and the cost in temperature link is reduced;

2) Extending application into a field that requires higher operating accuracy, further including extending application into a field that requires to keep operating accuracy unchanged while the service life in accuracy link is improved and the cost in accuracy link is reduced;

3) Extending application into a field that requires higher operating pressure, further including extending application into a field that requires to keep operating pressure unchanged while the service life in pressure link is improved and the cost in pressure line is reduced;

4) Extending application into a field that requires function expansion, further including extending application into a field that requires to keep function unchanged while the service life in function link is improved and the cost in function link is reduced;

5) Extending application into integrated, complex, macro-scale, micro-scale, heavy-duty, light-weighting, intensified, super-intensified, better automatized, better intellectualized fields and other more intensive and extensive fields;

6) Extending application into a field that requires to develop and improve the form and construction of a dynamic device.

To realize the aim of this invention, the dynamic technology approaches and measures taken still include:

1. For the extension of application into the field that requires higher operating temperature, the following measures can be taken:

1) Enhancing cooling intensity, including: adding internal cooling; increasing the flow rate and heat-transfer area of a cooling medium; enhancing the heat conductivity coefficient of a cooling medium (choosing medium with higher heat conductivity); enhancing the heat conductivity coefficient of a device that requires enhanced cooling (choosing materials with higher heat conductivity for fabrication).

2) Increasing the motion velocity V of a device that is in contact with high temperature zone and allowing its relative residence time in high temperature zone to be reduced to the allowable range. When V<3 m/s cannot meet the requirement of allowable range, choose 3-50 m/s, or choose 50-300 m/s if necessary, or even higher.

3) Transferring high temperature zone, allow high temperature zone to move (continuously or discontinuously), so as to avoid heating some operating points with overload.

4) For metallurgical furnace and other high-temperature reaction vessels, adding “transitional link” between the vessel and high-temperature reactant in case the temperature is higher than the melting point of the vessel, so as to utilize the heat transfer inertia of the “transitional link” to retain (confine) the high-temperature reactant in proper spatial scale. For example the “skull furnace” in metallurgical furnace and the inertia confinement link in nuclear reactions.

5) Changing the construction, material quality and other pertinent parameters of a dynamic device so as to favor the realization of the above improvement measures.

2. For the extension of application into the field that requires higher accuracy, the following measures can be taken:

1) Applying the dynamic technology of this invention to make breakthrough in the construction and material selection that constrain the large improvement of accuracy in sensor link.

2) Applying the dynamic technology of this invention to change the transmission mechanism, transmission construction and material selection in transmission link so as to largely improve transmission accuracy.

3) Applying the dynamic technology of this invention to increase spectrum width, implement “resonance excitation” of multi-components and multi-routes, so as to largely improve the accuracy in analysis and treatment link.

4) Applying the dynamic technology of this invention to add an automatic error correction system that responds to situation (self-adapting) and so to improve accuracy.

5) Applying the dynamic technology of this invention to add more dynamic forming links, reduce the forming correction amount or cutting amount or gauge reduction in each link, that is, to apply the principle of “broaching” into roll compacting to improve accuracy.

6) Applying the dynamic technology of this invention to implant superfinishing processing link in place of conventional finishing processing and so to improve accuracy.

7) Applying the dynamic technology of this invention to develop “focusing” function and multi-stage focusing, and form “high energy beam” cutting tools with sufficient accuracy to replace ordinary forming tools. Since the cutting force of high energy beam cutting is extremely small, it is quite easy to largely improve forming accuracy, for example, as illustrated in FIG. 9, the roller-type multi-stage focusing dynamic electrode system will generate high energy beam and realize multi-stage focusing.

3. For the extension of application into the field that requires wider operating pressure range, the following measures can be taken:

1) Applying the dynamic technology of this invention to minimize the active volume of pressure space, for example to minimize the free space (the furnace chamber space excluding molten pool and slag pool) in metallurgical furnace chamber, for example the relative motion of upper and lower furnace body or crystallizers in FIGS. 2 and 3.

2) Applying the dynamic technology of this invention to reduce the dimension of the operating system to an extent that is easy for the realization of pan seal.

3) Applying the dynamic technology of this invention to manufacture weldless high pressure vessels with largely improved pressure bearing performance.

4. For the extension of application into the field that requires function expansion, the following measures can be taken:

1) Adding more functions: including adding cooling function dynamic link (the water flow of circulating water cooling system) and at the same time adding power transmission link for power transmission function, for example as illustrated in FIG. 7(5); adding agitation function and restraining mass crashing function in power conduction function process of dynamic electrode, for example, to make skewed slot on the wheel circumference of rotating wheel electrode as illustrated in FIG. 1(B), FIG. 2 and FIG. 7.

2) Breaking through threshold: changing the pertinent parameters (including rotation speed, dimension, voltage, current and the like) of a dynamic link and the amount of dynamic link pieces, amount of operating positions, or changing the construction and material selection, or applying selective combinations, to break through the original functional threshold.

3) Creating new functions: changing static link into dynamic link, especially for electrified link, a dynamic process in which new electromagnetic field is generated will produce several new effects and functions which are absent from original static link.

5. For the extension of application into combined, integrated, complex, macro-scale, micro-scale, heavy-duty, light-weighting, intensified, super-intensified, automatized, intellectualized fields and other more intensive and extensive fields, the following measures can be taken:

Allowing the pertinent technology of this invention and the pertinent prior art to:

1) Selectively combine, mutually implant (copying, transferring);

2) Selectively integrate, mutually graft (with added special interface);

3) Selectively compound, mutually penetrate (with added special interface treatment);

4) Selectively bind, interreact-interact (enhancing innovation effect).

The form, construction, design outline and parameter selection about the dynamic devices of this invention

1. Form and Construction

The direct copying of form and construction of prior art dynamic devices is difficult or impossible to meet the extension requirement of this invention, accordingly, improvements and developments in various aspects are required, and the form and construction of the dynamic devices employed in this invention include mainly (with dynamic electrode as basic representative example herein):

1.1 Rotating tube type: as shown in FIGS. 1(A), 2(12), 3(6), 14, 4(9), 5(2), 8(8) and 9(2, 3) for example, it involves rotary motion and axial motion, features small dimension and low fabrication cost, and is generally used in applications where the operating temperature is not very high. Rotating roller, rotating cone and other rotary bodies with big axial dimension are encompassed.

1.2 Rotating wheel type: as shown in FIGS. 1(B), 2(1), 4(4), 5(8), 6(1), 7(5), 8(7), and 9(6). Presented in FIG. 6 is a rotating-wheel dynamic electrode system driven by motor and cooled by water spray from inner supporting tube. Its applications include: ST-CPC one-step melt coating (ST is a code representing this invention; the same below); ST spray coating; electrical conduction system for ST crystallizer, and etc.

In the figure:

1: rotating-wheel dynamic electrode

2: electrical conductivity (power transmission) ring support

3: insulated driving belt

4: tube clamp side of supporting stand (clamping inner-supporting spray tube)

5: inner-supporting spray tube

6: inlet hose connector

7: packing ring

8: insulated bush

9: choke plug

9.1: jet hole

9.2: water-spray internal cooling chamber

10: gasket

11: water-out collection chamber side of supporting stand

11.1: water-out collection chamber

12: outlet hose connector

13: motor

The above construction can be realized in two modes of insulation design:

1) Semi-insulation (small system insulation): rotating wheel electrode system (dynamic electrode system) is insulated and is driven by insulated belt, while non-dynamic electrode system (cooling system (water cooling)) is not fully insulated (with weak current, and conduction is made through water).

2) Full insulation (big system insulation). The design that water cooling system (including water tank, motor, frame, driving system) is electrified while is insulated from other systems is encompassed.

Smooth wheel, gear wheel, belt wheel are encompassed, which generally have only rotary motion and radial motion, feature big dimension and high fabrication cost, and are suitable for various temperatures. Rotating ring, rotating disk and other rotary bodies with big radial dimension are encompassed.

1.3 Strip-shape dynamic end type: including rotating-wheel dynamic end type, for example, as shown in FIGS. 7(5) and 1(C).

Caterpillar dynamic end type is shown in FIG. 1(D).

The “strip shape” can be implemented in cylinder shape to directly replace prior art graphite electrode for applications where the current is small and the temperature is not very high.

The rotating wheel can have the functions of driving, power transmission, cooling and the like at the same time, as shown in FIG. 1(C)(b) for example.

FIG. 7 shows a rotating-wheel dynamic end electrode (type A)

In the figure:

1. water inlet connector; 2. air inlet connector (if necessary); 3. water outlet connector; 4. electrode body; 5. rotating wheel electrode; 6. axial flow type paddle wheel; 7. tightening screw.

Design outline:

1. Adopt pressurized seal if necessary;

2. Driving mode of rotating wheel:

Type A: hydraulically;

Type B: pneumatically;

Type C: by motor (the driving member is arranged inside assembly 4).

1.4 Bullet type, overlapped bullet type, combined bullet type, for example as shown in FIG. 1(I).

Suitable for dynamic pulse electrode, manufacturing is complicated, can be used in various temperatures.

1.5 Dart type, overlapped dart type, combined dart type, continuous-overlapping crimp-connection throwing bar type, for example as shown in FIG. 1(J).

Suitable for pulse or continuous dynamic electrode, manufacturing is complicated, can be used in various temperatures. The types mentioned above in 3.1.4 and 3.1.5 are the evolved forms from rotating tube dynamic electrode by evolving axial motion into high-speed throwing motion, evolving short rotating tube section into “bullet”, and evolving long rotating tube section into “dart” or “bar”. Manufacturing and cooling mechanism are both complicated. They are suitable for certain special applications where the types mentioned in 3.1.1, 3.1.2 and 3.1.3 are not competent. The furnace chamber is quite compact, and several pertinent systems necessary for 3.1.1, 3.1.2 and 3.1.3 can be cancelled.

1.6 Combined skipped-stitch type (combined needle-cluster type) (combined sewing needle type) dynamic elements are similar to sewing needle cluster. Both dense and sparse combination arrangements are allowed, and are suitable for regulating temperature field and other parameter fields in large spatial scale.

1.7 Driving belt type, as shown in FIG. 1(G) for example. Driving thread type and driving string type are encompassed.

1.8 Sequential rest type: the combination of several dynamic elements with each element takes a rest by turns.

1.9 Integrated type: the combination or integration of the above several types.

2. Design Outline

The following problems concerning the above-mentioned dynamic devices (especially dynamic electrode) are generally necessary to be solved for the adoption of the extended dynamic technology of this invention:

2.1 Sealing problem: mainly the dynamic sealing problem generated from the newly-added cooling system or the dynamically modification of the original sealing system. Generally multiple sealing and high-temperature sealing links are to be added. And when necessary, pressurized sealing link (hydraulic or pneumatic) (to blockout leakage path or force leaks to go back by making use of back pressure) and dynamic sealing link (for example dynamic phase-change sealing, a dynamic sealing link established by making use of the dynamic equilibrium relationship of sealing link or sealant's liquid-solid phase self-adapting change) can be added.

2.2 Insulation problem: especially when high voltage is used, it is generally required to design for a higher insulation level according to high temperature, high pressure, high current and high voltage.

2.3 Safe operation problem, especially the links that are subject to safety problems including high temperature, explosion, splashing, highly corrosive, poisonous and etc. Generally complete enclosure design is adopted and can be implemented in multiple steps.

2.4 Resistance problem, with aim to reduce dynamic energy consumption and prevent dynamic failure. Generally cooling and lubrication are to be considered combinedly. The settlement of the above problem generally requires only to directly implant the pertinent part in prior art, then after actually measuring and simulating the resistance reduction effect of dynamic device (including making skewed slot, pushing away or removing or crashing restraining mass by air flow and other simple while effective measures), and after several runs of commissioning and design, the task can be fulfilled satisfactorily (with the task according to the aim of this invention realized). If better effects are required, the present inventor can otherwise provide pertinent technical scheme, for example by directly applying the thoughts in this invention to extend dynamic technology for the resolution of problems, in this way, transnormal better effects can be brought about.

3. Parameter Selection

3.1 Selection principle: try as best for high velocity, high voltage, high current, small size, strong cooling, complete enclosure, ultrahigh temperature, super-intensification, light weight, low energy consumption, low resource consumption, low cost, high benefit, zero pollution, zero waste, zero emission, and large market volume.

3.2 Selection procedure: 1) selecting according to prior art and leaving margin for link optimization. 2) optimizing and adjusting according to this invention after formal production. 3) utilizing more preferred scheme otherwise provided by the present inventor when necessary.

3.3 Selection range:

A. Motion velocity of a dynamic device: for circular motion, V=3-30 m/s; for special circular motion: V=1-300 m/s; for rectilinear motion: V=1-10 m/s; for special rectilinear motion: V=0.3-100 m/s;

B. Operating voltage: 0.15-10 times of prior art operating voltage;

C. Operating current: 0.10-25 times of prior art operating current;

D. Minimum dimension: 2-9 times smaller than prior art dimension, or even an order of magnitude smaller;

E. Maximum dimension: 2-9 times larger than prior art dimension, or even an order of magnitude larger;

F. Cooling intensity: 0.15-10 times of prior art cooling intensity;

G. Complete enclosure degree and ultrahigh pressure: 2-1000 times of prior art enclosure degree and the corresponding pressure, or even higher;

H. Ultrahigh temperature: 100-3000° C. higher than prior art, or even higher;

I. Waste: 2-1000 times less than prior art, or even lesser;

J. Emission pollution degree: 2-1000 times less than prior art, or even lesser.

When dynamic electrode is used as the basic representative example for the extended application of a selective combination, the prior art electrode is changed from static to dynamic, or the construction, material quality, cooling mode, pertinent parameter of the prior art dynamic electrode is appropriately modified according to this invention, thereby to obtain transnormal application field extension and effects.

The inventive dynamic technologies formed or produced accordingly from the modification of prior art by applying the dynamically changing method according to this invention include:

1) The inventive dynamic technical link that corresponds to prior art static technical link, or the improved dynamic technical link of this invention that corresponds to prior art dynamic technical link;

2) The inventive dynamic technology that corresponds to prior art static technology, or the improved dynamic technology of this invention that corresponds to prior art dynamic technology;

3) The corresponding technological process and technological equipment involved in the inventive dynamic technical link or the improved dynamic technical link of this invention and the inventive dynamic technology or the improved dynamic technology of this invention;

4) The products with transnormal or significantly transnormal industrial application effect that are produced from the inventive dynamic technology or the improved dynamic technology of this invention.

This invention has the following major advantages:

1. Can largely improve performance: the implementation of this invention is more favorable for:

1) adopting higher-performance materials;

2) adopting composite materials;

3) adopting composite construction;

4) adopting three-dimensional compressing stress forming (the optimum forming stress status);

5) adopting combined intensification, especially the realization of local combined intensification in high stress area by applying the dynamic hot spray coating of this invention.

2. Can largely reduce weight (if necessary).

3. Can largely reduce cost: the implementation of this invention is more favorable for the realization of:

1) one-step forming;

2) one-step material formation: for example one-step steelmaking—continuous casting and continuous rolling;

3) times of increase of local intensification or super-intensification effect.

4. Can largely save energy and develop new energy source: the implementation of this invention is most favorable for the realization of:

1) reduction of intermediate links and thus energy saving;

2) reduction or improvement of pole effect and thus energy saving;

3) providing conditions for the breakthrough of large-scale adoption of innovative energy sources, for example the upgrade of the various high energy batteries (especially fuel cells); the industrial application of solar energy, hydrogen energy and nuclear energy;

5. Can largely save resources and develop new resources: the implementation of this invention is most favorable for the realization of:

1) ultrahigh temperature special metallurgy and one-step complete dissociation, where the existing resource input is utilized sufficiently, the various target products are output in a single step, and zero waste is approached.

2) artificial synthesis of various new resources under ultrahigh temperature and ultrahigh pressure.

6. Can thoroughly improve environmental protection from the root and alter harsh environment: the implementation of this invention is most favorable for the realization of:

1) abolishment of graphite electrode (including carbon electrode and carbon electrode paste) and the eradication of CO₂ pollution thus generated;

2) reduction of carbon reduction, realization of complete enclosure circulation of CO reduction, and nearly zero emission;

3) complete enclosure circulation of other productions, realization of nearly zero pollution and nearly zero emission. The spatial dimension of a device according to this invention is largely reduced, even possible of 1-2 orders of magnitude smaller than the corresponding prior art, and the volume is reduced 3-6 orders of magnitude;

4) active environmental protection: altering harsh environment to good and providing fundamental support for technological economy.

7. Can continuously exploit new market in a large scale of area.

### BRIEF DESCRIPTION OF DRAWINGS

FIG. 1 shows the major forms of a dynamic device, wherein, <A> is rotating tube type, <B> is rotating wheel type, <C> is rotating-wheel dynamic end type, <D> is caterpillar dynamic end type, <E> is dynamic combined inner-outer cylinder face type, including dynamic combined inner-outer cylinder face electrolysis electrode, <F> is dynamic combined rotating end face type, including dynamic combined rotating end face electrolysis electrode, <F.a> is the combination of two rotating end faces: co-axis <a> left; not co-axis <a> right, <F.b> is the combination of multiple rotating end faces, <G> is driving belt type, dynamic combined driving belt type, including dynamic driving belt planar-type electrolysis electrode, <H> is combined need-cluster type, <I> is bullet type, <J> is dart type.

FIG. 2 shows a dynamic arc furnace, wherein, <A> is upper furnace body assembly, <B> is lower furnace body assembly, <C> is pedestal assembly (scale drawing)

FIG. 3 shows an ST titanium ingot melting process, wherein, <A> is front view, <B> is side view, <C> is top view, and <E> is a simple construction of a dynamic arc furnace

FIG. 4 shows a working principle schematic of an ST-CPC one-step melt coating roller

FIG. 5 shows a working principle schematic of an ST one-step dynamic-electrode axial melt coating roller

FIG. 6 shows a rotating-wheel dynamic electrode system

FIG. 7 shows an rotating-wheel dynamic end electrode

FIG. 8 shows a crankshaft formed in a single step efficiently and continuously

FIG. 9 shows a basic construction of an ST high-energy particle beam gun

FIG. 10 shows an ST dynamic three-phase arc furnace

### MODE FOR CARRYING OUT THE INVENTION

In a first aspect: application examples from the view of construction member

### EXAMPLE 1

### Dynamic Electrode

The working electrodes in prior art metallurgical furnaces, electrolytic baths, various electrically powered physical and chemical reaction vessels, various electrical engineering installations and their technological processes (including various electric welding), various technological processes and their devices where electrode is used (with the existence of electrode) are generally relatively static (in relatively fixed and simple mechanical movement status when in operation, including relatively static status), generally susceptible to consumption and damage, and are generally the weak links in the radical breakthrough and innovation of prior art technological processes, furthermore, pole effect is generally associated by high power energy wastage, the controllable range of pole effect is narrow, and undesirable pole effect often account for large proportion.

If these electrodes were modified into dynamic electrodes, by selecting appropriate electrode materials, construction forms and dynamic parameters, the above problems associated with prior art static electrode can be solved.

The construction forms, design outlines and parameter selection about dynamic electrode have been described as above, the material may be selected from copper and other materials with high electrical and thermal conductivity or other materials; the cooling type may be selected from external cooling, internal cooling or the combination thereof.

### EXAMPLE 2

### Dynamic Vessel

(1) Dynamic reactor: the construction members in contact with reactants, such as the roof, cover, wall, base, and water outlet of metallurgical furnace, are generally featuring short service life, high maintenance cost, and are generally one of the major links that restrict the radical breakthrough and innovation of prior art (for example, ultrahigh temperature, ultrahigh pressure, ultrahigh corrosion, corrosion, erosion and etc.). If to in part or completely modify such members into dynamic links according to this invention, these problems can be solved besides that dynamic furnace chamber can additionally mix reactants effectively.

(2) Dynamic mold: for example compression mold: the reason why the compression casting of ferrous metals and the compression casting of heavy parts are difficult to realize is that compression mold is the major restriction link. By in part or completely modifying into “dynamic compression mold” according to this invention, these difficulties can be overcome, and even realize nearly zero-friction compression casting.

(3) Dynamic crystallizer: for example continuous casting crystallizer. The casting blanks from prior art continuous casting are generally formed under tensile stress when pulled out under certain conditions, the blanks are of poor quality, the casting speed is extremely low (<1 m/s) and is unmatched with rolling speed (>10 m/s). If to modify such crystallizer into dynamic crystallizer according to this invention, these problems can then be solved from the root, and even high-speed one-step compression-injection molding can be realized, at which time, the dynamic crystallizer is evolved into dynamic forming channel.

### EXAMPLE 3

### Other Dynamic Devices

The dynamic technology of this invention can be considered for the resolution of any weak links in prior art, especially when it is used to change the motion status of prior art systems, the innovation effect is most outstanding. The high-speed motion of dynamic devices can also be combined with power system, cooling system and newly-added reaction system for more purposes.

In a second aspect: application examples from the view of function and industry

### EXAMPLE 1

### Dynamic Industrial Furnace

(1) Dynamic Arc Furnace (Including Various Submerged Arc Furnaces)

As illustrated in FIGS. 2, 3(E) and 10 for example.

FIG. 2 shows an ST dynamic arc furnace (multifunctional and versatile type). In the figure:

1. rotating-wheel dynamic electrode; 2. current-conducting arm and water inlet/outlet pipe; 2.1. power unit for furnace-roof dynamic electrode; 3. dynamic electrode rotating shaft and water inlet/outlet pipe; 4. water outlet channel; 5. water inlet channel; 6. upper furnace body; 6.1. furnace roof; 6.2. left and right furnace wall (sliding wall); 7. chimney flue (with pusher mechanism inside; small furnace can be charged through furnace door); 8. telescopic (movable) chimney flue; 9. one-way valve (for continuous melting or vacuum melting); 10. power unit for furnace-base dynamic electrode; 11. lower furnace body; 11.1. furnace base; 11.2. front and back sliding wall; 12. rotating-tube dynamic electrode; 13. tapping hole (slag-free tapping hole); 14. flue hole (or movable-door hole); 15. guiding column; 16. pedestal with tilting mechanism.

Outline for process design:

1. The selection of dynamic electrode: several single or combined arrangement(s) can be designed for the type and form (for example the commonly seen rotating-wheel or rotating-tube type). At the time of design, the furnace temperature requirement, vacuum degree requirement (pressure requirement), atmosphere requirement, cooling requirement, power supply requirement and control requirement should be determined first according to the nature and scale of the intended product, then the agitation requirement, refining requirement and combined intensification requirement should be determined, and then the general guiding principle (major technical economic indices) should be determined. The final design (one or more dynamic electrode(s), single phase or multiphase, AC or DC) is to be made after comprehensive technical economic analysis based on combined consideration of capital condition, technical strength, manufacturing condition, management condition and other actual conditions.

2. The up and down of electrode can be achieved by 6 and 11 alone or in combination, and can also be achieved by breaking down into smaller parts (the smaller parts of 6 and 11). When multiple electrodes are employed, the up and down of each electrode can be made separately.

3. For furnace-base electrode, when small height (compactness) is required, it is most preferred to choose packaged dynamic rotating tube electrode, and in operation, the mechanical damage arisen from charging should be decreased to the minimum allowable value.

4. The tapping hole of small furnace can also be used as observation hole; if necessary, observation hole and furnace door can be arranged on 6-2.

5. The requirements to rotating-wheel dynamic electrode: 1) weight: <¼ of graphite electrode with same power; 2) permissible current density when in operation: 20 or more times higher than graphite electrode; 3) fabrication cost: <⅓ of graphite electrode; 4) sealing property: 2 or more levels higher than graphite electrode; 5) operation and maintenance cost: <⅓ of graphite electrode; 6) service life: 10 or more times longer than graphite electrode; for the satisfaction of the above requirement, the temperature of cooling water is generally lower than 30□, and the water pressure is higher than 0.3 MPa; 7) rotating-wheel dynamic electrode can be manufactured by adopting copper tubing composite construction.

6. The correct and adequate utilization of skull furnace technology (slag skull, alloy skull) is one of the technical keypoints, especially for links as 6-2, 11-2 and 12 for example.

7. After the process becomes stable completely, gradually change to continuous melting, with no up and down of dynamic electrode and no sliding of furnace body.

Molten steel is to be transferred by pressure.

Many variations can still be made according to this invention, where the differences in the outline for process design include: 1. to determine electrode type based on the comparison with complete rotating-wheel or complete rotating-tube electrode; 2. to realize start up, arc generation and steel tapping with dynamic electrode keeping stationary while furnace body 11 and 6 going up and down and tilting; 3. one of the combination forms of dynamic electrode: a combination of rotating wheel and rotating tube, as shown in FIG. 2 for example.

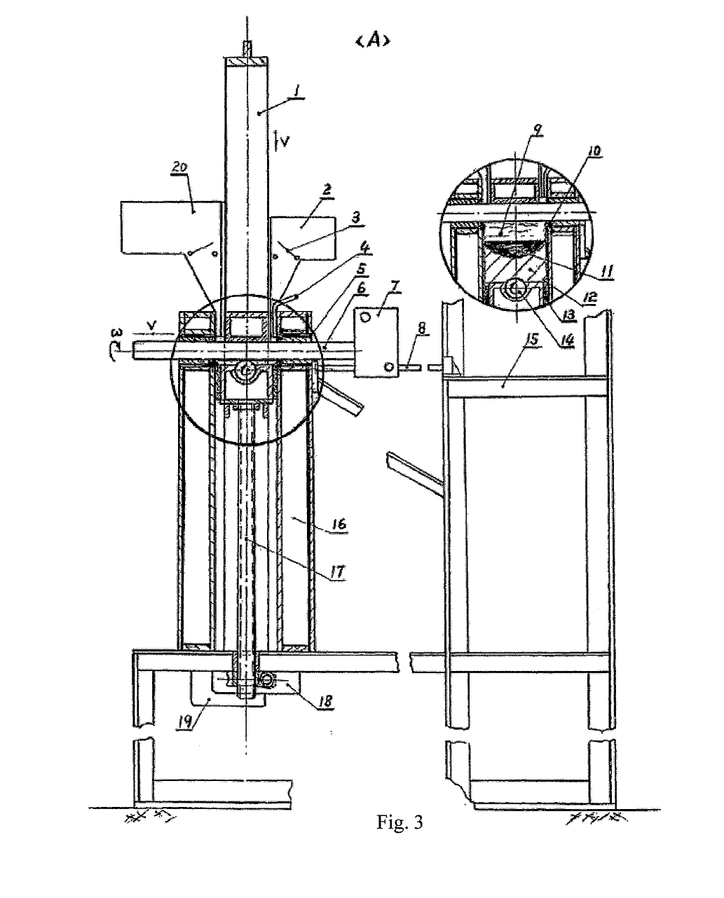

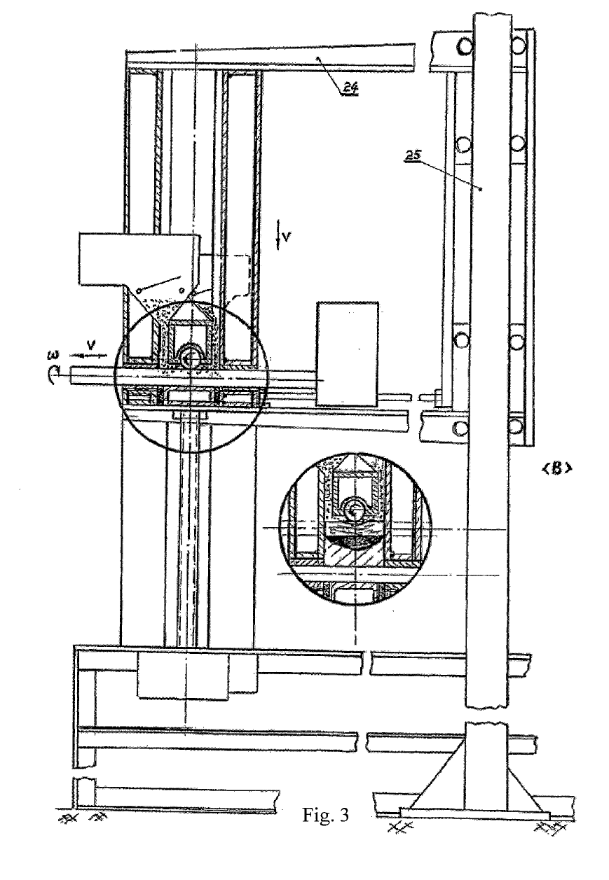

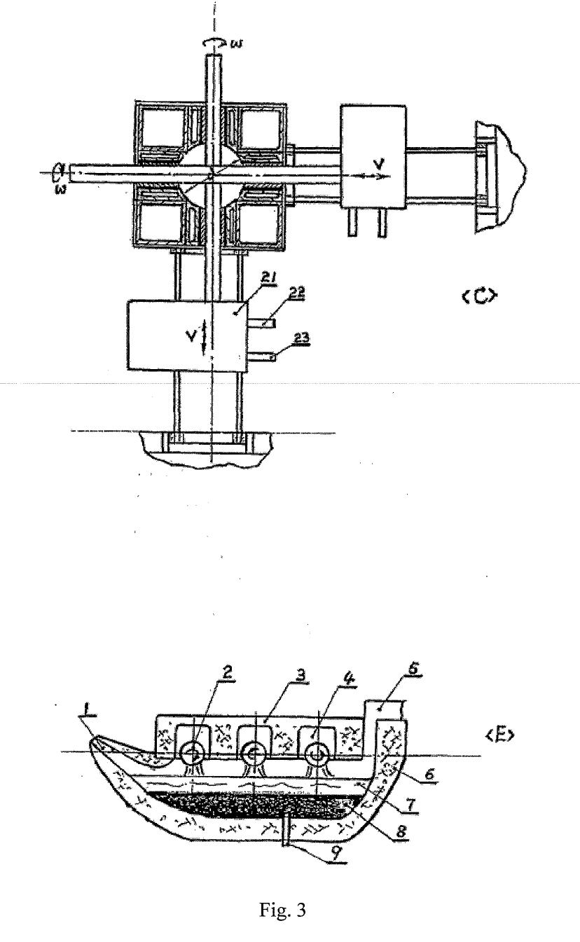

FIG. 3(E) shows a simple construction of dynamic arc furnace: ST three-phase lined dynamic arc furnace.

In the figure: 1. eccentric tapping hole; 2. rotating-tube dynamic electrode; 3. furnace cover; 4. crystallizer; 5. chimney flue; 6. furnace body; 7. slag pool; 8. molten pool; 9. furnace-base electrode (grounded).

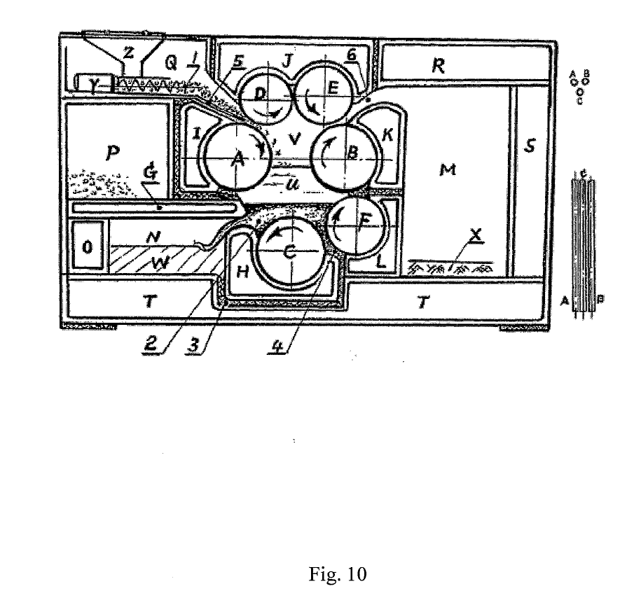

FIG. 10 shows another ST dynamic arc furnace (multipurpose type).

In the figure:

A. phase-A dynamic rotating-tube (or rotating-wheel or other rotating objects; the same below) electrode; B, C: phase B, C electrode; D, E: dynamic rotating-tube (or wheel etc.) furnace roof; F: dynamic rotating-tube (or wheel etc.) furnace wall; G. crystallizer on top of casting mold cavity (N); H. furnace-base crystallizer (cooling C); I. furnace-wall crystallizer (cooling A); J. furnace-roof crystallizer (cooling D, E); K. furnace-wall crystallizer (cooling B); L. furnace-wall crystallizer (cooling F); M. condensation chamber; N. casting mold cavity; O. crystallizer on the movable sidewall of casting mold cavity; P. roasting chamber (or sintering chamber; when used as sintering chamber, it is connected with V through the channels (not shown) between A and D); Q. charging chamber; R. crystallizer on top of condensation chamber; S. crystallizer on the sidewall of condensation chamber; T. crystallizer on pedestal; U. slag pool; V. upper space in hearth; W. product (melted alloy casting); X. condensation product; Y. materials pusher; Z. feed hopper; 1. materials (furnace charge); 2. melted alloy pool; 3. insulated pieces (liner); 4. slag skull; 5. material entrance with one-way gate; 6. furnace gas exit with one-way gate.

Design outline:

1. Can be simplified to single-phase furnace, lined furnace, electroslag furnace, and can also be modified to vacuum furnace;

2. Skull furnace technology can be adopted if necessary.

3. The cooling, insulation and resistance reduction (to decrease transmission consumption and prevent from choking) means should be determined according to melting conditions (mainly the furnace temperature and product nature). The water outlet for melting alloy can be changed to “dynamic water outlet” (containing double roller dynamic gate) or water-cooling dynamic rotating-tube (or wheel etc.) furnace wall.

(2) Dynamic electroslag furnace

As illustrated in FIGS. 3, 8 and 10 for example.

It includes the adoption of dynamic permanent non-consumable electrode, includes the adoption of dynamic crystallizer, and further includes the adoption of various dynamic electroslag casting apparatuses or other specialized apparatuses for electroslag casting.

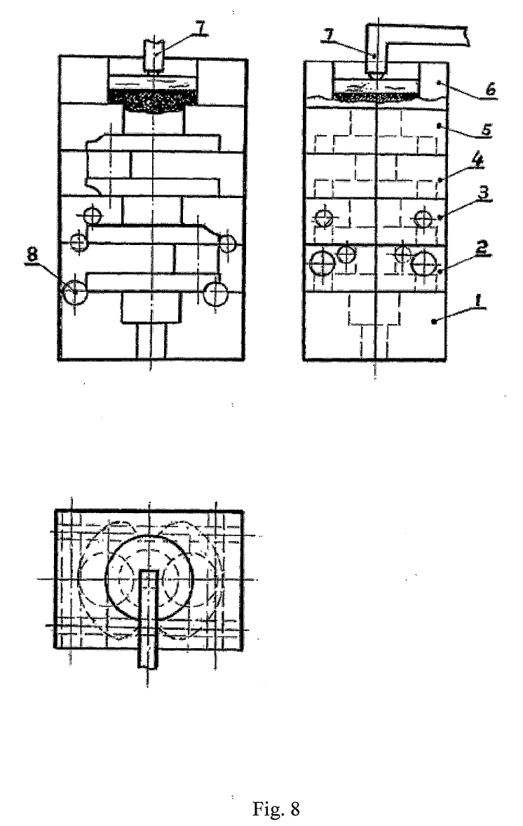

FIG. 8 shows a crankshaft formed in a single step efficiently and continuously

An ST dynamic electrode is adopted, molten steel can be casted from top or side face directly, and consumable electrode is not required. In the figure:

1, 2, 3, 4, 5, 6. die layer; 7. primary-heating dynamic electrode (submerged arc heating or open arc heating); 8. illustration of secondary-heating dynamic electrode (adopted when necessary);

The high-efficient one-step continuous forming technology is disclosed in another patent granted to the present inventor entitled “The integral continuous electroslag casting of crankshaft and similar parts using local upright mold with circular upwelling: process and equipment”.

(3) Dynamic integrated furnace: integrated utilization of resistance heat, arc heat, electroslag heat, induction (vortex) heat and other heat sources.

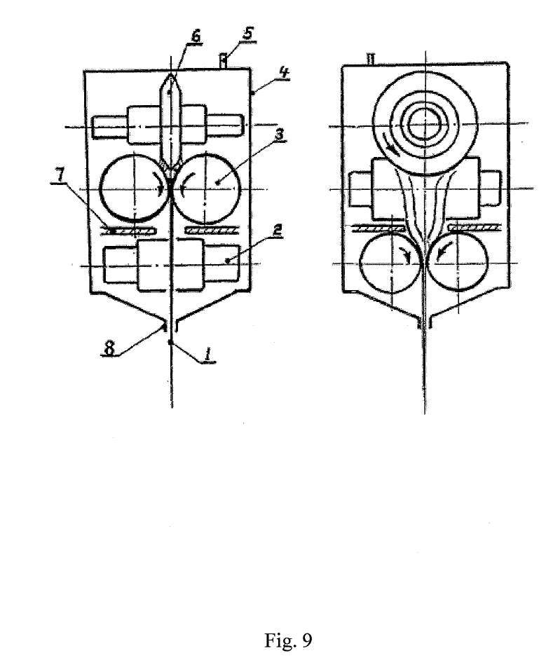

(4) Dynamic ultrahigh temperature furnace: dynamic electrode+dynamic furnace chamber+skull furnace intermediate link (dynamic gradient temperature field). For example the combination of FIGS. 9 and 10, wherein slag skull and alloy skull are evolved into skull furnace liner, ultrahigh temperature thermal dissociation, ultrahigh temperature electrochemical reactor and ultrahigh temperature electromagnetic effect device are included.

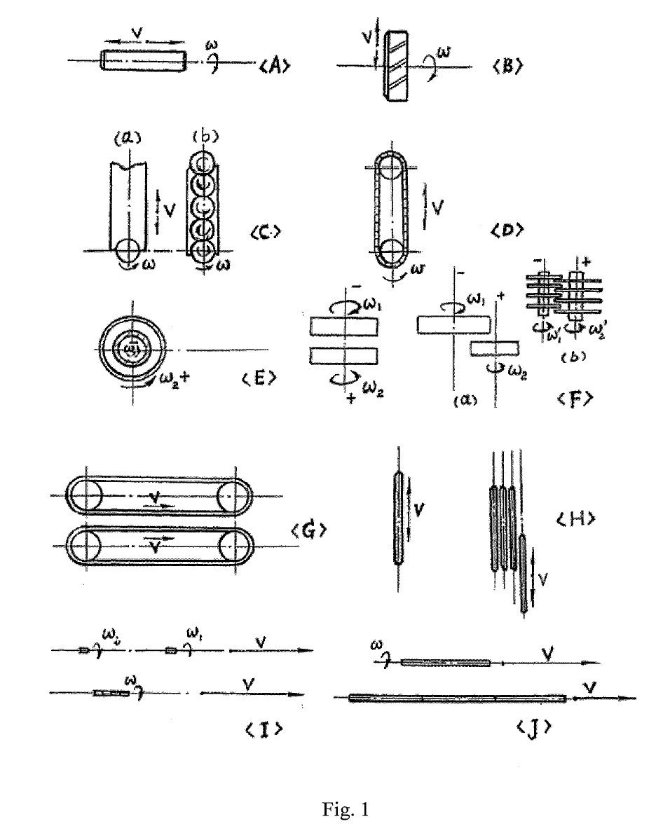

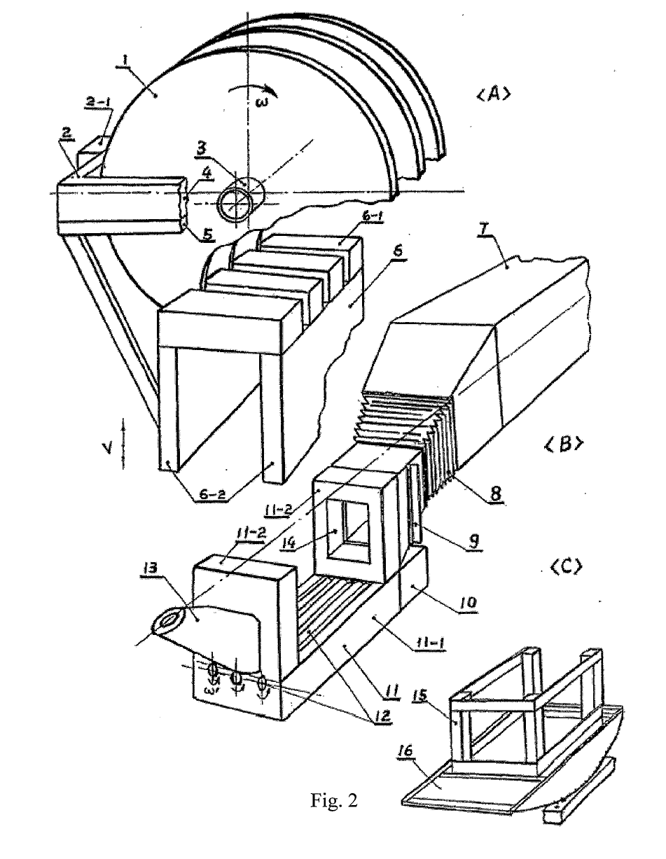

(5) Dynamic electrolytic bath: the dynamic electrolysis electrode can be of rotating inner-outer cylinder face type, or rotating end face type, or dynamic driving belt planar type, and etc., for example the (E), (F) and (G) in FIG. 1.

(6) Dynamic cracking furnace: including various tube furnaces; the heat source may be electric heat, chemical heat and integrated heat.

### EXAMPLE 2

### Dynamic High-Energy Beam Gun

FIG. 9 shows a basic construction of an ST high-energy particle beam gun

In the figure:

1. plasma beam or electron beam (high-energy particle beam); 2. roller type focusing dynamic electrode (the 3^{rd} stage); 3. roller type focusing dynamic electrode (the 2^{nd} stage); 4. gun shell; 5. air inlet (or air outlet); 6. rotating wheel dynamic electrode (the 1^{st} stage, emitting electrode); 7. insulation partition; 8. jet tip.

Design outline:

1. 2, 3 or more stages are possible;

2. Decide the voltage across stages and polarity according to requirement;

3. Preliminarily choose the type, pressure and flow rate of compressed gas according to conventional technical parameters, and after commissioning to stable, make use of the construction advantages of the gun to increase power input to the optimum value.

4. When used as electron beam gun, the voltage across stages, the vacuum degree and the compile of operating procedures can be preliminarily determined based on medium pressure; commissioning can also start from the combination with plasma gun to preliminarily choose pertinent values by referring to prior art conventional parameters; then after the process becomes stable, gradually increase current and voltage to the optimum values.

The abovementioned high-energy beam gun includes dynamic plasma gun, dynamic electron gun, dynamic laser gun, dynamic high-energy light beam gun, dynamic high-energy microwave beam gun, and the like.

### EXAMPLE 3

### Dynamic Continuous Coating (CPC)

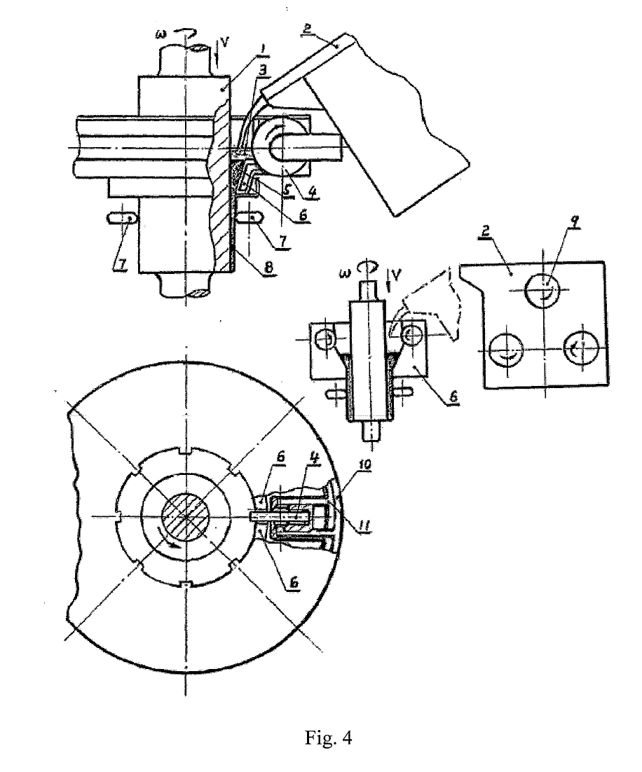

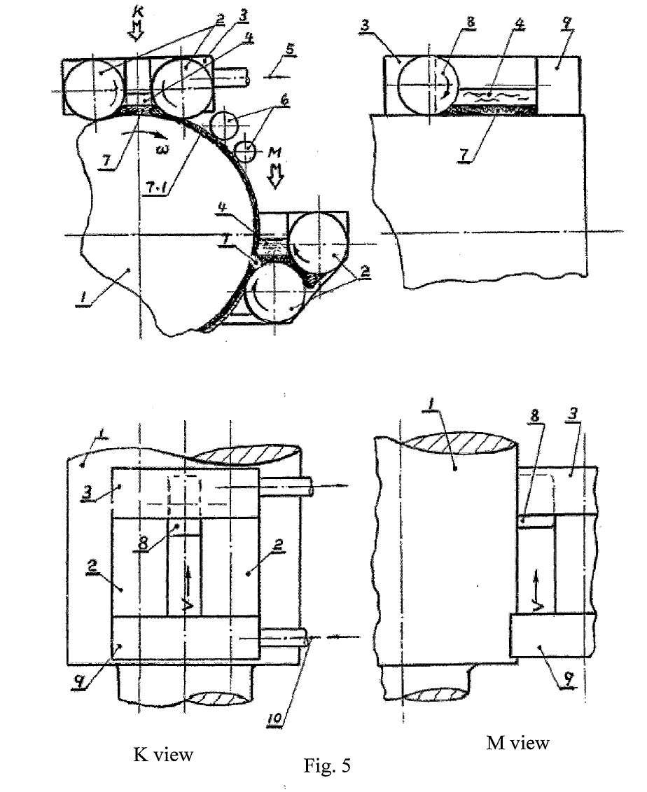

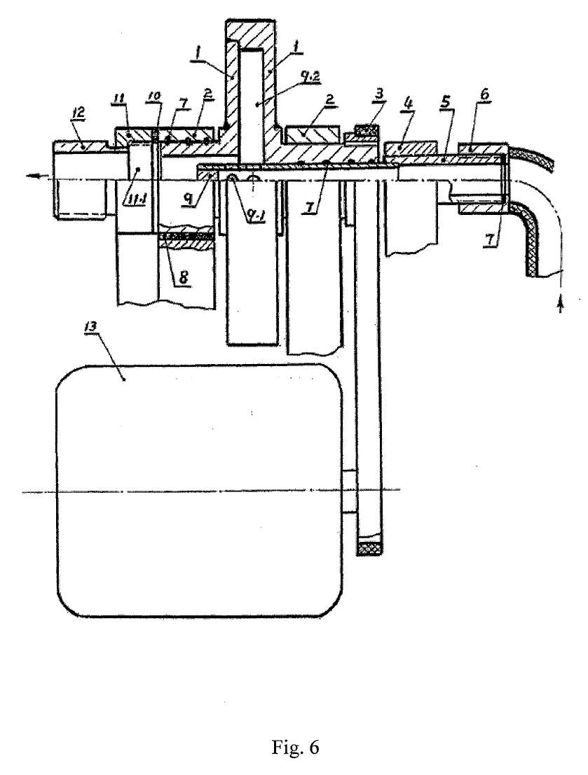

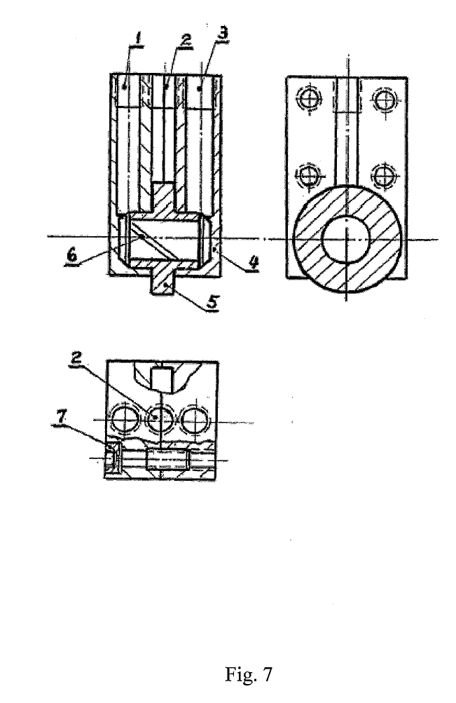

As shown in FIGS. 4 and 5 for example.

Including dynamic electrode, dynamic crystallizer and dynamic combined intensification

FIG. 4 shows a working principle schematic of an ST-CPC one-step melt coating roller

In the figure:

1. roller; 2. ST dynamic-electrode three-phase arc furnace; 3. slag pool; 4. rotating wheel dynamic electrode; 5. molten pool; 6. crystallizer; 7. roller wheel (for intensification by rolling); 8. melt coating layer; 9. rotating tube dynamic electrode; 10. water inlet chamber ring; 11. water outlet chamber ring

Design outline:

1. Both sealing and insulation can be made by “air pressure method” (making use of the balance between air pressure and resistance) if necessary; range can be determined by resistance test made on insulation layer and rotating electrode to establish a self feedback self-adapting equilibrium system.

2. The dynamic electrode driving force can be motor force (electromagnetic force), water force, hydraulic force or pneumatic force.

3. It is best to regulate power input by regulating voltage, and if necessary, the means of moving dynamic electrode can also be adopted.

4. Molten steel can be transported by pipeline when necessary.

FIG. 5 shows a working principle schematic of an ST one-step dynamic-electrode axial melt coating roller (melt-coating forming generant: the axial generant of roller cylinder face, part or full length).

In the figure:

1. roller; 2. rotating-tube dynamic electrode; 3. side-seal crystallizer (with dynamic rotating wheel); 4. slag pool; 5. water out; 6. intensification-purpose roller wheel; 7. molten pool; 7.1. melt coating layer; 8. dynamic rotating wheel; 9. side-seal crystallizer (without dynamic rotating wheel); 10. water in; 1-10 assembly: ST dynamic-electrode melt coating roller.

Design outline:

1. The amount of melt coating rollers (amount of assemblies) and the position as well as the length of the rotating-tube electrode are to be determined according to the type, nature, number and batch of the coating layer after the process becomes stable, and are to be adjusted further for better performance in production.

2. The melt coating end face and cylinder have intersecting edges; certain technological auxiliaries can be added appropriately so that the edges protrude to certain extent, and then process to remove them or roll to remove them.

3. The melting and incorporation of alloy into melt coating layer are to be made by referring to ST dynamic industrial furnace (such as those mentioned above) or by the various conventional means.

### EXAMPLE 4

### Dynamic Hot Spray Coating

Including dynamic electrode and dynamic combined intensification

Including dynamic arc spray coating, dynamic high-energy beam spray coating

### EXAMPLE 5.2.5

### Dynamic Titanium Ingot Melting, Dynamic Electrode+Dynamic Crystallizer

As shown in FIG. 3 for example.

FIG. 3 shows an ST titanium ingot melting process,

<A>: front view, <B>: side view, <C>: top view

In the figure:

1. movable (up and down) crystallizer; 2. slag hopper; 3. one-way valve; 4. air inlet/outlet pipe (for vacuum pumping or argon charging); 5. insulation layer; 6. furnace-roof dynamic rotating-tube electrode; 7. power unit for furnace-roof dynamic electrode; 8. guiding rail; 9. slag pool; 10. slag skull; 11. molten pool; 12. titanium ingot; 13. porcelain ring or intensification-purpose slag skull; 14. furnace-base dynamic rotating-tube electrode; 15. rack; 16. stationary crystallizer; 17. ingot leading mechanism; 18. power unit for ingot leading (reduction gear); 19. vibrator (if necessary); 20. feed hopper; 21. power unit for furnace-base dynamic electrode; 22. outlet pipe connector; 23. inlet pipe connector; 24. trolley-type lifting crossbar; 25. vertical shaft

Outline for process design:

1. By adopting combined type (“letterpress plate” type) crystallizer, titanium ingot with other cross section (square, rectangular and etc.) can be produced.

2. Several dynamic electrodes can be adopted with AC, DC, single-phase or multi-phase power supply.

3. The ingot leading means in this design is stable and reliable, the release from mold is simple, and is easy to increase ingot leading speed. When necessary, the ingot leading pole can not use dynamic electrode, conventional ingot leading means can be adopted; for power transmission, hydraulic means and reel means are both allowed; the height of crystallizer can be reduced; the crystallizer outlet can employ dynamic crystallizer technology.

4. Several air inlets/outlets can be arranged; add flue gas outlet if necessary.

5. Use vibrator if necessary and the design can refer to conventional continuous casting ingot crystallizer. Multifunctional stepless continuous on-load-tap-changing type is most preferred.

6. The design of the flame retardant coating in high-temperature zone is critical; it must meet the various requirements of fire proof, long service life, insulation, air proof, pollution free, low resistance and etc. at the same time, and if necessary, “air pressure method” can be adopted.

7. This design is simple and reliable; further evolution to continuous smelting, continuous casting and continuous rolling can be made after the process becomes stable.

8. Generally V is between 1 and 10 m/s and V_{ω} is between 3 and 30 m/s (V: average velocity of the reciprocating motion of dynamic electrode; V_{ω}: peripheral linear velocity of dynamic electrode).

Other applications include dynamic spraying gun nozzle, dynamic high energy battery, dynamic strong electric light source, dynamic laser, dynamic nuclear reactor, dynamic fusion reactor and the like.

### INDUSTRIAL PRACTICABILITY

Taking ST dynamic arc furnace as an example. Compared with AC arc furnace, the furnace of this invention has better industrial practicability:

1. Higher product performance

1) easy to realize low carbon, trace carbon or even zero carbon;

2) favorable for vacuum melting, more favorable for melting in protective atmosphere; air tightness is largely enhanced; the equivalent melting chamber volume is largely reduced;

3) favorable for the reduction of melting pollution to zero pollution (skull furnace, crystallizer);

4) favorable for the regulation and control of temperature and time, thus to accurately control composition;

5) favorable for the realization of ultrahigh temperature; in the first stage, the average temperature in furnace chamber can reach 2000-3000□, and later, 3000-5000° C. or even higher temperature can be realized;

6) favorable for the functioning of electrochemical reactions;

7) favorable for refining and foreign matter removal (with the realization of high efficient agitation along dynamic electrode);

8) favorable for combined intensification;

2. Lower cost

1) graphite electrode abolished, cost decreased 3-5%;

2) installation cost decreased 5-20 times; the technological transformation investment can be returned in the same year;

3) throughput increased 20-50%; the ultrahigh temperature melting throughput can be increased for 100%;

4) some ores can be introduced directly; finally one-step steel making realized;

5) bottom electrode problem thoroughly solved, maintenance cost reduced 3-10 times, service life prolonged 3-10 time;

6) electric power consumption decreased 10-20% (1^{st} generation); the consumption decreased 20-40% for the 2^{nd} generation; and for the generations later on, higher performance can be achieved.

For the 1^{st} generation, with the combined effect of 1) to 6), steel cost per ton can be reduced for 20-30 US dollars (common steel), or even 50 US dollars;

Steel cost per ton for special steel can be reduced for 30-50 US dollars, or even 100 US dollars;

For the generations later on, the cost can be further reduced.

3. Nearly zero pollution, especially in aspect of dust, noise and CO₂;

4. Easy to implement, popularize and command, and easy to realize automation;

5. Is possible to be popularized in a large scale of area (half adopts high-impedance three-phase ST dynamic arc furnace, especially submerged arc furnace) and become a predominating metallurgical means.

6. Favorable for the creation of various ultrahigh-temperature short-stage one-step special electrometallurgy and ultrahigh-temperature electrometallurgy/electrolysis (including high-temperature carbon reduction and ultrahigh-temperature thermal dissociation, thermal cracking) to obtain various metals or alloys and corresponding byproducts thereof directly from ores in a single step; resources consumption can be lowered for 1-3 times, or even 3-5 times or higher; energy consumption can be lowered for 1-3 times, or even 3-5 times or higher. The working principle schematic is given in FIG. 10 “an ST dynamic three-phase arc furnace (multipurpose type)”.

7. Especially favorable for the production of titanium alloys, refractory metals and the alloys thereof, for example manganese alloy, silicon alloys, chrome alloys, titanium alloys, niobium, ferroniobium and the like.

For another example: dynamic aluminum electrolysis

A dynamic electrolytic bath can solve inert electrode problem in the electrometallurgy of aluminum, with nearly zero pollution, largely reduced electric energy consumption and much lower cost, and is easy to be evolved to dynamic one-step forming and material forming.

The combination with other dynamic electric furnaces can bring in the evolution of dynamic one-step special metallurgy of aluminum to replace the prior art aluminum electrolysis process.

For example dynamic ultrahigh-temperature metallurgy

The implementation of this invention can realize an average furnace chamber (reaction chamber) temperature of 2000° C., 3000° C., 4000° C., 5000° C., or even higher.

Ultrahigh-temperature metallurgy can open up a new world for metallurgy, for example the realization of ultrahigh-temperature thermal dissociation, thermal cracking, and thermal decomposition; the one-step separation of various valuable materials from ores; the realization of nearly zero emission, nearly zero waste, and nearly zero pollution; the exploitation of quite broad fields and amazing effects for new materials, new energy sources and new technological processes by making use of ultrahigh-temperature electrochemical reaction, electrodynamic reaction, electromagnetic reaction, and nuclear reaction that are difficult to realize by prior art.

For another example, the exploitation of dynamic high-energy beam gun and dynamic confinement technology will provide conditions for nuclear fusion.

For a further example, dynamic crystallizer will largely prolong the service life of crystallizer, improve product quality, decrease cost, and as described above, can realize one-step steel making (continuous casting and continuous rolling).

For a further example, dynamic spraying gun nozzle can realize the large increase of service life, large increase of operating pressure, and trigger off revolutionary changes in metallurgical industry such as steel making.

And can exploit the new field of high-pressure cutting and upgrade the prior art mining, etc.

For a further example, dynamic electroslag metallurgy and dynamic electroslag casting can further improve the rapid electroslag metallurgy most recently invented by today's developed countries, further improve the shaped pieces uniform step forming technology (for example integral one-step electroslag casting of crankshaft) invented by the present inventor in early days, further improve product quality, improve throughput, reduce cost, decrease energy and material consumption, reduce pollution, and expand application field.

Can allow the previous melt casting of crankshaft to realize continuous forming with one-time decreased installation investment, overcome the extrusion difficulties, tap molten steel from above, and realize quick forming in a single step (FIG. 8).

For a further example, dynamic melt coating, as shown in FIGS. 4 and 5.

For example, dynamic continuous coating (ST-CPC technique) can allow times of decrease in installation investment in CPC technique, obviously improve product quality (especially the effective agitation of slag pool and molten pool as well as the run-out quality of dynamic crystallizer), easy to realize multi-layer compounding, and largely expand the application field.

For a further example, dynamic hot spray coating can from the root overcome the two deadly weaknesses of low binding strength and high porosity associated with prior art spray coating, for the dynamic hot spray coating of this invention adopts dynamic electrode and dynamic combined intensification, so it's easy to realize spray coating with large area and high energy density, and continuous, smooth and stable regulation and control of spray coating parameters.

The general design and implementation outline and the industrial application outline of the examples according to this invention as well as the application field extensions are summarized below.

By using the selective combination of this invention with various products, various technological processes and various technological equipment in various industries to appropriately modify the prior art into the corresponding dynamic technology of this invention can produce hundreds of technical schemes, innovation and inventions as well as invention patents with quite outstanding technical economic effects.

1. Appropriately modifying the material quality, construction, parameter, pertinent working and manufacturing process in the weak links or problematic links in prior art technologies including electrode technology, vessel technology, industrial furnace technology, high-energy beam gun technology, continuous coating technology (CPC), hot spray coating technology, titanium ingot melting technology, spraying gun nozzle technology, battery technology and high energy battery technology, electric light source technology and strong electric light source technology, laser technology, nuclear reaction technology and etc. according to the corresponding part of the dynamic technology of this invention from static link or imperfect dynamic link into corresponding ST dynamic link or improved ST dynamic link.

2. For the difficulties in modification, such as sealing problems associated with high temperature and high pressure, reliability problems related to nearly zero resistance, and etc., in the first step of design, 2-3 turns of tracking and commissioning will be conducted by actually measuring and simulating dynamic link based on corresponding prior art technology to determine the formal production process and the pertinent parameters as well as design or choose the corresponding equipment; in this way, the task of this invention, that is, gradually modifying prior art into the corresponding ST dynamic technology to realize transnormal or even significantly transnormal improvements of application field extension and effects in quality, performance, function, lifetime, reliability, cost, benefit, profit, intensification, super-intensification, weight, energy consumption, resource consumption, temperature, pressure, purity, energy density, pollution, emission, wastage, environment, production level, automation, intelligence and market aspects, can generally be fulfilled satisfactorily.

3. The second step: gradually and further optimize and finalize the design through industrial production.

4. The third step: 1) further renew and upgrade by comprehensively making use of the dynamic technology of this invention; 2) utilize the more optimal scheme otherwise provided by the present inventor when necessary.

5. The various prior art material preparation technologies, including the various metallurgical technologies and the various nonmetal material, composite material preparation technologies, can all be modified into the corresponding dynamic material preparation technologies according to this invention, which is characterized in that by employing the dynamic industrial furnace of this invention and by comprehensively utilizing this invention to modify the weak links or problematic links in prior art preparation technologies to realize transnormal or even significantly transnormal improvements of application field extension and effects.

6. The prior art manufacturing technologies, including the various casting, forging, welding technologies, the various performance treatment technologies and the various special shape and property imparting technologies (such as the various plating technologies, spray coating technologies, one-step melt coating (CPC) technologies), can all be modified into the corresponding dynamic shape and property imparting technologies according to this invention, which is characterized in that by employing the dynamic technological equipment of this invention and by comprehensively utilizing this invention to appropriately modify the difficulties in the technological process thereof to realize transnormal or even significantly transnormal improvements of application field extension and effects.

7. The selective combinations of the various dynamic technical links of this invention and the various relatively independent parts are especially favorable for providing fundamental breakthrough and innovation conditions for leading subjects in various industries, especially the various sophisticated industries, including newly emerging petrochemical industry, newly emerging energy sources, newly emerging ocean industry, aerospace industry, nuclear industry, and bioengineering, gene engineering and etc., for this invention can function to realize transnormal or even significantly transnormal improvements in advanced manufacturing and advanced materials.

8. The modification of the prior art according to this invention to allow prior art to gradually evolve into the corresponding dynamic technology will produce numerous new technologies, new products, new technological processes, new energy sources, new information and other innovative achievements, which will exhibit much stronger industrial application effects than the historical status developed in the conventional static technical fields, especially for the resolution of deep seated technical difficulties in the foundation, core and leading links of prior art, this invention can act as a paving stone to contribute to technical advancement.

9. The phrase “transnormal or even significantly transnormal improvements” in this application document is used to illustrate the specific quantification relationship between application field extension and the effects, for according to the writing principle and implementation principle of this invention, any one of ordinary skill in the art can, without making any creative efforts, get the various general quantification results just by making use of elementary knowledge and conventional judging principle in prior art.

10. Summary description

Since the thoughts contained in this invention contain many contents and encompass even more application fields and more representative examples (appreciably numerous), the writing of this specification is more difficult than conventional patent documents: on one hand, if to involve too much information, it will bring difficulties to examination and management, also is not favorable for the understanding and application by users; on the other hand, if to file too many divisions, except for bringing in larger examination load, it is also not convenient for patent examination and management, even more difficult to materialize the fundamental tenet of patent law, that is, allowing users to have a comprehensive and intensive command over the patent and can easily conceive of other variations so as to obtain optimum benefits.

According to the relevant regulations in patent law, to positively support examination and facilitate the command over this patent and the application of this patent to solve the various technical problems and difficulties to the maximum by users, herebelow some other descriptions are given:

10.1 About Writing Principle

The specification of this invention is written according to patent law in a manner as concise, accurate and complete as possible; it is intended for design and implementation persons of ordinary skill in the art; the outlines for process design and implementation are given and drawings are appended. For the criterion of “sufficient disclosure”, one of the major cases referred to is an application for a patent for invention entitled “Four Stroke Internal Combustion Engine with Tandem Cylinder and Reciprocating Piston”, wherein the descriptions are quite concise: only the technical characteristic about the changing of cylinder arrangement from traditional parallel mode to tandem mode and the advantages thus brought in are described, while the differences between the other parts of this internal combustion engine and the traditional parallel-cylinder engine are not described at all; the appended drawing is only a simple figure, and in the figure, the pistons in the upper and lower cylinders are connected with a bar, at both sides of the piston in the upper cylinder are combustion chambers, above the piston in the lower cylinder is combustion chamber, while the lower side of the piston is connected with a link lever and crankshaft. In both the substantial examination and re-examination processes of this patent application, it was rejected by examiner for “insufficient disclosure”. The examiner deems that the new tandem mode arrangement of cylinders will inevitably bring in some construction changes to certain parts of the traditional parallel-cylinder internal combustion engine, for example the steam distribution design of the engine, so the applicant should clearly present the schemes for the construction changes that can only be solved with creative efforts of those skilled in the art. The applicant refused and appealed, and in the stage of court hearing, the applicant presented a searched document to prove that persons skilled in the art can adopt prior art technologies to solve the design problem of the steam distribution of the system without any creative efforts. Thereby, the court made a decision to withdraw the former rejection. (The writing and examination of patent application documents in machinery field. Zhang Rongyan, Intellectual Property Publishing House, 1^{st} edition, May 1997, p 135).

The writing of this application agrees with the decision of the court, and is favorable for the defense of patent doctrine, implementing the tenet (general principle) of patent law, and getting rid of the unhealthy circle of “approval—invalidation—re-approval—re-invalidation”. At the same time, it seeks to reduce the unnecessary workload of design and implementation persons as well as examiners, and tries as best to realize the object that those skilled in the art can make designs and implementations and realize the aim of this invention simply by referring to ordinary textbooks and reference books of the art, and only when higher aim is pursued, is there the necessity to search for those less known literature and information.

10.2 About Implementation Principle

This application document sets forth “selective combination, appropriate modification” as one of the principles for the implementation of this invention (that is, by targeting at the problematic and weak links in prior art to selectively combine a certain or some element/elements (link/links) in the many links (elements) according to this invention and impart appropriate modifications, the aim of the invention can thus be realized). Herebelow are the reasons:

1) For technicians of ordinary skill or even technical workers of ordinary skill in the art, when to solve certain technical problem, they need only to conduct based on elementary knowledge taught in ordinary textbooks and ordinary design handbooks in the art and according to the approaches, measures, conditions, procedures (steps), forms, constructions, outlines for process design and parameters selection set forth in this specification; in this process, no creative efforts are needed, while some laborious basic efforts are necessary (the basic laborious efforts necessary to solve, by making use of this patent, the technical problems that cannot be solved by prior art), that is, contrasting each part of content contained in this invention with the corresponding prior art one by one for several times to obtain better understanding, then seriously and finely investigating and comparing each of the examples and appended drawings given in the invention one by one repeatedly to gradually deepen understanding till have a thorough command, then gradually making more exercises to develop the ability of solving various technical difficulties that cannot be solved previously, and finally reaching the extent of flexible application and immediately calling to mind several (generally no less than ten) technical schemes for the resolution of the technical difficulty.

2) The final appropriate scheme can be determined through conventional comparison and optimization according to conventional design principles and practical conditions while without paying creative efforts.

3) For more skilled implementation body (especially those outstanding innovative teams), the optional schemes and effects are of course more and better.

10.3 About General Conclusions

The phrase “transnormal or even significantly transnormal improvement” in this application document is used to illustrate the specific quantification relationship between application field extension and the effect, for according to the above writing principle and implementation principle, any technician of ordinary skill in the art can, without making any creative efforts, get the various general quantification conclusions just by making use of elementary knowledge and conventional judging principle in prior art. For example:

A representative product chosen in this specification for this invention is “dynamic high-energy beam gun”, and much general descriptions are omitted. As for dynamic plasma gun only, the below three general conclusions will be obvious (or trivial or can be deduced without paying creative efforts) to any technicians engaged in the research, development, design, production and application of prior art plasma engineering:

1) Plasma engineering is a major and leading subject in today's world, besides the application in nuclear fusion and other military engineering, it has been widely used in almost all the civil engineering fields and has exhibited tremendous commercial value. So long as the cost can be reduced to be lower than the point of competition by relevant industries, then it is likely to trigger unparalleled technological revolution and industrial revolution.

2) The restraint link in plasma engineering is high-energy beam gun (generally plasma gun, the same below), which features short lifetime, complicated construction and high fabrication cost currently. The dynamic high-energy beam gun of this invention can prolong lifetime for 3-10 times, or even hundreds of times; much wider applications can be found, and is most favorable for the adoption of hydrogen or other new energy sources to realize recycling economy. Currently, metallurgical industry, machinery industry, chemical industry (especially coal chemical industry, petrochemical industry, and synthetic chemical industry), new material industry, new energy source industry, information industry, aerospace industry, ocean industry, traffic industry, excavation industry, construction industry, environment protection industry, biological engineering, gene engineering and other relevant industries are the fields in which it can be used can get effect most instantly. For example when used in steel industry, it can largely improve product quality, save energy, save materials, and reduce pollution, and the steel cost per ton can be reduced for 20-200 US dollars.

3) As for ST dynamic plasma engineering only, it can provide fundamental breakthrough conditions for the further large-pace development of nearly one hundred kinds of high and new technologies, thus driving the large development of both traditional and new industries to obtain large benefits; only to consider the non-fusion non-military international market volume, the benefit can already reach or even surpass 1000 billion US dollars.

1. An application extension of dynamic technology to change a motion state parameter of a prior art technical link, including to change the construction, material quality and parameter of a prior art technical link, it is generally to firstly change a certain or some prior art technical links from stationary into relatively moving, and then choose, based on the specific technical matter or technical problem intended to be solved, proper combinations from the following various approaches and measures for the realization of extended application of prior art dynamic technology, to render appropriate modification, including modifying a prior art static technical link into a corresponding dynamic technical link, or modifying a prior art dynamic technical link into a corresponding improved dynamic technical link; gradually modifying a prior art static technology into a corresponding dynamic technology, or gradually modifying a prior art dynamic technology into a corresponding improved dynamic technology, to break through the limited threshold value in the art, and realize transnormal or even significantly transnormal application field extension and application effects
the various approaches and measures for the realization of extended application of prior art dynamic technology include at least one of the following:
1) Extending application into a field that requires higher operating temperature, further including extending application into a field that requires to keep operating temperature unchanged while the service life in temperature link is improved and the cost in temperature link is reduced;
2) Extending application into a field that requires higher operating accuracy, further including extending application into a field that requires to keep operating accuracy unchanged while the service life in accuracy link is improved and the cost in accuracy link is reduced;
3) Extending application into a field that requires higher operating pressure, further including extending application into a field that requires to keep operating pressure unchanged while the service life in pressure link is improved and the cost in pressure line is reduced;
4) Extending application into a field that requires function expansion, further including extending application into a field that requires to keep function unchanged while the service life in function link is improved and the cost in function link is reduced;
5) Extending application into integrated, complex, macro-scale, micro-scale, heavy-duty, light-weighting, intensified, super-intensified, better automatized, better intellectualized fields and other more intensive and extensive fields;
6) Extending application into a field that requires to develop and improve the form and construction of a dynamic device.

2. An application extension of dynamic technology according to claim 1, further comprising taking the following measures to realize the application field extension and effects associated with higher operating temperature:
1) Enhancing cooling intensity, including: adding internal cooling; increasing the flow rate and heat-transfer area of a cooling medium; enhancing the heat conductivity coefficient of a cooling medium (choosing medium with higher heat conductivity); enhancing the heat conductivity coefficient of a device that requires enhanced cooling (choosing materials with higher heat conductivity for fabrication);
2) Increasing the motion velocity V of a device that is in contact with high temperature zone and allowing its relative residence time in high temperature zone to be reduced to the allowable range. When V<3 m/s cannot meet the requirement of allowable range, choose 3-50 m/s, or choose 50-300 m/s if necessary, or even higher;
3) Transferring high temperature zone, allow high temperature zone to move continuously or discontinuously, so as to avoid heating some operating points with overload;
4) For metallurgical furnace and other high-temperature reaction vessels, adding “transitional link” between the vessel and high-temperature reactant in case the temperature is higher than the melting point of the vessel, so as to utilize the heat transfer inertia of the “transitional link” to confine high-temperature reactant in proper spatial scale, wherein the “skull furnace” in metallurgical furnace and the inertia confinement link in nuclear reactions are encompassed;
5) Changing the construction, material quality and other pertinent parameters of a dynamic device so as to favor the realization of the above improvement measures.

3. An application extension of dynamic technology according to claim 1, further comprising taking the following measures to realize the application field extension and effects associated with higher operating accuracy:
1) Applying the dynamic technology of this invention to make breakthrough in the construction and material selection that constrain the large improvement of accuracy in sensor link;
2) Applying the dynamic technology of this invention to change the transmission mechanism, transmission construction and material selection in transmission link so as to improve transmission accuracy;
3) Applying the dynamic technology of this invention to increase spectrum width, implement “resonance excitation” of multi-components and multi-routes, so as to improve the accuracy in analysis and treatment link;
4) Applying the dynamic technology of this invention to add an automatic self-adapting error correction system and so to improve accuracy;
5) Applying the dynamic technology of this invention to add more dynamic forming links, reduce the forming correction amount or cutting amount or gauge reduction in each link, that is, to apply the principle of “broaching” into roll compacting to improve accuracy;
6) Applying the dynamic technology of this invention to implant superfinishing processing link in place of conventional finishing processing and so to improve accuracy;
7) Applying the dynamic technology of this invention to develop “focusing” function and multi-stage focusing, and form “high energy beam” cutting tools with sufficient accuracy to replace ordinary forming tools. Since the cutting force of high energy beam cutting is extremely small, it is quite easy to largely improve forming accuracy.

4. An application extension of dynamic technology according to claim 1, further comprising taking the following measures to realize the application field extension and effects associated with higher operating pressure:
1) Applying the dynamic technology of this invention to minimize the active volume of pressure space, for example to minimize the free space in metallurgical furnace chamber;
2) Applying the dynamic technology of this invention to reduce the dimension of the operating system to an extent that is easy for the realization of pan seal;
3) Applying the dynamic technology of this invention to manufacture weldless high pressure vessels with improved pressure bearing performance;

5. An application extension of dynamic technology according to claim 1, further comprising taking the following measures to realize the application field extension and effects associated with function expansion:
1) Adding more functions: including adding cooling function dynamic link—the water flow of circulating water cooling system, and at the same time adding power transmission link for power transmission function; adding agitation function and restraining mass crashing function in power conduction function process of dynamic electrode, for example, to make skewed slot on the wheel circumference of rotating wheel electrode;
2) Breaking through threshold: changing the pertinent parameters, including rotation speed, dimension, voltage, current and the like of a dynamic link, and the amount of dynamic link pieces, amount of operating positions, or changing the construction and material selection, or applying selective combinations, to break through the original functional threshold;
3) Creating new functions: changing static link into dynamic link, especially for electrified link, a dynamic process in which new electromagnetic field is generated will produce several new effects and functions which are absent from original static link.

6. An application extension of dynamic technology according to claim 1, further comprising taking the following measures to realize application extension into integrated, complex, macro-scale, micro-scale, heavy-duty, light-weighting, intensified, super-intensified, better automatized, better intellectualized fields and other more intensive and extensive fields:
Allowing the pertinent technology of this invention and the pertinent prior art to:
1) Selectively combine, so as to realize mutual implantation through copying and transferring;
2) Selectively integrate, so as to realize mutual grafting with added special interface;
3) Selectively compound, so as to realize mutual penetration with added special interface treatment;
4) Selectively bind, mutually interreact—so as to realize interactions that enhance innovation effect.

7. An application extension of dynamic technology according to claim 1, wherein the form and construction of the dynamic devices employed include mainly:
1) Rotating tube type, wherein the dynamic device is a tube piece with rotary motion and reciprocating axial motion;
2) Rotating wheel type, wherein smooth wheel, gear wheel, belt wheel, rotating ring, rotating disk and other rotary bodies with big radial dimension are encompassed, and generally with only rotary motion and radial motion;
3) Strip-shape dynamic end type: including rotating-wheel dynamic end type, caterpillar dynamic end type, and the strip shape can be implemented in cylinder shape, including the direct replacement of prior art graphite electrode without modifying other construction of prior art furnace;
4) Bullet type, overlapped bullet type, combined bullet type, including the dynamic device that is suitable for use in dynamic pulse electrode;
5) Dart type, overlapped dart type, combined dart type, continuous-overlapping crimp-connection throwing bar type;
6) Combined skipped-stitch type, combined needle-cluster type, combined sewing needle type—similar to sewing needle cluster, both dense and sparse combination arrangements are allowed;
7) Sequential rest type: the combination of several dynamic elements with each element takes a rest by turns.
8) Driving belt type, wherein driving thread type and driving string type are encompassed.
9) Integrated type: the combination or integration of the above several types.

8. An application extension of dynamic technology according to claim 1, wherein general keypoints in design are to solve the following problems concerning dynamic devices:
1) Sealing problem: mainly the dynamic sealing problem generated from the newly-added cooling system or the dynamically modification of the original sealing system. Generally multiple sealing and high-temperature sealing links are to be added. And when necessary, hydraulic or pneumatic sealing link that uses back pressure to blockout leakage path or uses back pressure to force leaks to go back and dynamic sealing link established by making use of the dynamic equilibrium relationship of sealant's liquid-solid phase self-adapting change can be added;
2) Insulation problem, especially when high voltage is used, it is generally required to design for a higher insulation level according to high temperature, high pressure, high current and high voltage;
3) Safe operation problem, especially the links that are subject to safety problems including high temperature, explosion, splashing, highly corrosive, poisonous and etc. Generally complete enclosure design is adopted and can be implemented in multiple steps;
4) Resistance problem: with aim to reduce dynamic energy consumption and prevent dynamic failure. Generally cooling and lubrication are to be considered combinedly according to conventional same kind technology, then after actually measuring and simulating the resistance reduction effect of dynamic device and several runs of tracking, commissioning and design, the task can be fulfilled satisfactorily, including making skewed slot, removing or crashing restraining mass by air flow and other simple while effective measures.

9. An application extension of dynamic technology according to claim 1, further comprising choosing pertinent parameters according to the following regulations:
1) Selection principle: try as best for high velocity, high voltage, high current, small size, strong cooling, complete enclosure, ultrahigh temperature, super-intensification, light weight, low energy consumption, low resource consumption, low cost, high benefit, zero pollution, zero waste, zero emission, and large market volume.
2) Selection procedure:
A. selecting according to prior art and leaving margin for link commissioning optimization;
B. optimizing and adjusting according to this invention during operation.
3) Selection range:
A. Motion velocity of a dynamic device: for circular motion, V=3-30 m/s; for special circular motion: V=1-300 m/s; for rectilinear motion: V=1-10 m/s; for special rectilinear motion: V=0.3-100 m/s;
B. Operating voltage: 0.15-10 times of prior art operating voltage;
C. Operating current: 0.10-25 times of prior art operating current;
D. Minimum dimension: 2-9 times smaller than prior art dimension, or even an order of magnitude smaller;
E. Maximum dimension: 2-9 times larger than prior art dimension, or even an order of magnitude larger;
F. Cooling intensity: 0.15-10 times of prior art cooling intensity;
G. Complete enclosure degree and ultrahigh pressure: 2-1000 times of prior art enclosure degree and the corresponding pressure, or even higher;
H. Ultrahigh temperature: 100-3000° C. higher than prior art, or even higher;
I. Waste: 2-1000 times less than prior art, or even lesser;
J. Emission pollution degree: 2-1000 times less than prior art, or even lesser.

10. An application extension of dynamic technology according to claim 1, wherein inventive dynamic technologies formed or produced accordingly from the modification of prior art by applying the dynamically changing method according to this invention include:
1) The inventive dynamic technical link that corresponds to prior art static technical link, or the improved dynamic technical link of this invention that corresponds to prior art dynamic technical link;
2) The inventive dynamic technology that corresponds to prior art static technology, or the improved dynamic technology of this invention that corresponds to prior art dynamic technology;
3) The corresponding technological process and technological equipment involved in the inventive dynamic technical link or the improved dynamic technical link of this invention and the inventive dynamic technology or the improved dynamic technology of this invention;
4) The products with transnormal or significantly transnormal industrial application effect that are produced from the inventive dynamic technology or the improved dynamic technology of this invention.
